(19) United States
(12) Patent Application Publication
(10) Pub. No.: US 2004/0134352 A1
(43) Pub. Date: Jul. 15, 2004

(54) Silica trap for phosphosilicate glass deposition tool

(76) Inventors: David Stacey, Portland, OR (US); James Michael Bennett, Portland, OR (US)

Correspondence Address: LSI LOGIC CORPORATION, 1621 BARBER LANE, MS: D-106 LEGAL, MILPITAS, CA, 95035, US

(21) Appl. No.: 10/341,669

(22) Filed: Jan. 13, 2003

(51) Int. Cl. B01D 45/00

(52) U.S. Cl. 95/267; 55/319

(57) ABSTRACT

A silica trap for a PSG deposition tool includes an expansion chamber, an inlet coupled to the expansion chamber to conduct an exhaust stream carrying silica powder from the PSG deposition tool into the expansion chamber so that the silica powder settles out of the exhaust stream to a bottom wall of the expansion chamber, and a discharge coupled to the expansion chamber to conduct the exhaust stream out of the expansion chamber.

### BACKGROUND OF THE INVENTION

1. Field of the Invention

The present invention is directed to a phosphosilicate glass (PSG) deposition process used in the manufacture of integrated circuits. More specifically, but without limitation thereto, the present invention is directed to a method of conducting an exhaust stream from a PSG deposition tool to a main exhaust line.

2. Description of the Prior Art

Phosphorus-doped silicon dioxide, commonly referred to as P-glass or phosphosilicate glass (PSG), is especially useful as a passivation layer because it inhibits the diffusion of impurities such as Na. PSG softens and flows at 950° C. to 1100° C. to create a smooth topography that is beneficial for depositing metals. A PSG deposition tool is typically used for depositing phosphosilicate glass in the manufacture of integrated circuits. The exhaust stream from the PSG deposition tool is typically connected to a facilities scrubbed exhaust line that is maintained at a selected vacuum to conduct silica powder and gases in the exhaust stream from the PSG deposition tool.

### SUMMARY OF THE INVENTION

In one aspect of the present invention, a silica trap for a PSG deposition tool includes an expansion chamber, an inlet coupled to the expansion chamber for conducting an exhaust stream carrying silica powder from the PSG deposition tool into the expansion chamber so that the silica powder settles out of the exhaust stream to a bottom wall of the expansion chamber, and a discharge coupled to the expansion chamber for conducting the exhaust stream out of the expansion chamber.

In another aspect of the present invention, a method of removing silica powder from an exhaust stream carrying silica powder from a PSG deposition tool includes steps for conducting the exhaust stream from a PSG deposition tool exhaust line through an inlet into an expansion chamber, settling the silica powder out of the exhaust stream to a bottom wall of the expansion chamber, and conducting the exhaust stream through a discharge out of the expansion chamber.

### DESCRIPTION OF THE DRAWINGS

The present invention is illustrated by way of example and not limitation in the accompanying figures, in which like references indicate similar elements throughout the several views of the drawings, and in which:

FIG. 1 illustrates a silica trap between a PSG deposition tool and a main exhaust line according to an embodiment of the present invention;

FIGS. 2A, 2B, 2C and 2D illustrate isometric, top, front and side views of the silica trap of FIG. 1;

FIG. 3 illustrates a flow chart for a method of removing silica powder from an exhaust stream carrying silica powder from a PSG deposition tool according to an embodiment of the present invention.

Elements in the figures are illustrated for simplicity and clarity and have not necessarily been drawn to scale. For example, the dimensions of some of the elements in the figures may be exaggerated relative to other elements to help to improve understanding of the following description of the illustrated embodiments.

### DESCRIPTION OF THE ILLUSTRATED EMBODIMENTS

During operation of a PSG deposition tool, silica powder accumulates in the exhaust line, requiring frequent cleaning and corresponding down time of the PSG deposition tool. In previous methods for removing the silica powder, the vacuum of the exhaust line is monitored at the PSG deposition tool. When the vacuum is less than a selected threshold value, for example, 4.5 mm Hg Vac, the PSG tool is removed and the entire exhaust line is cleaned. Disadvantageously, performance of the PSG deposition tool slowly degrades as the silica powder accumulates in the exhaust line, and substantial down time is required to clean the entire exhaust line. Another disadvantage of this maintenance procedure is that the silica powder enters the main facility scrubbed exhaust line and builds up over time.

In one aspect of the present invention, a silica trap for a PSG deposition tool includes an expansion chamber, an inlet coupled to the expansion chamber to conduct an exhaust stream carrying silica powder from the PSG deposition tool into the expansion chamber so that the silica powder settles out of the exhaust stream to a bottom wall of the expansion chamber, and a discharge coupled to the expansion chamber to conduct the exhaust stream out of the expansion chamber.

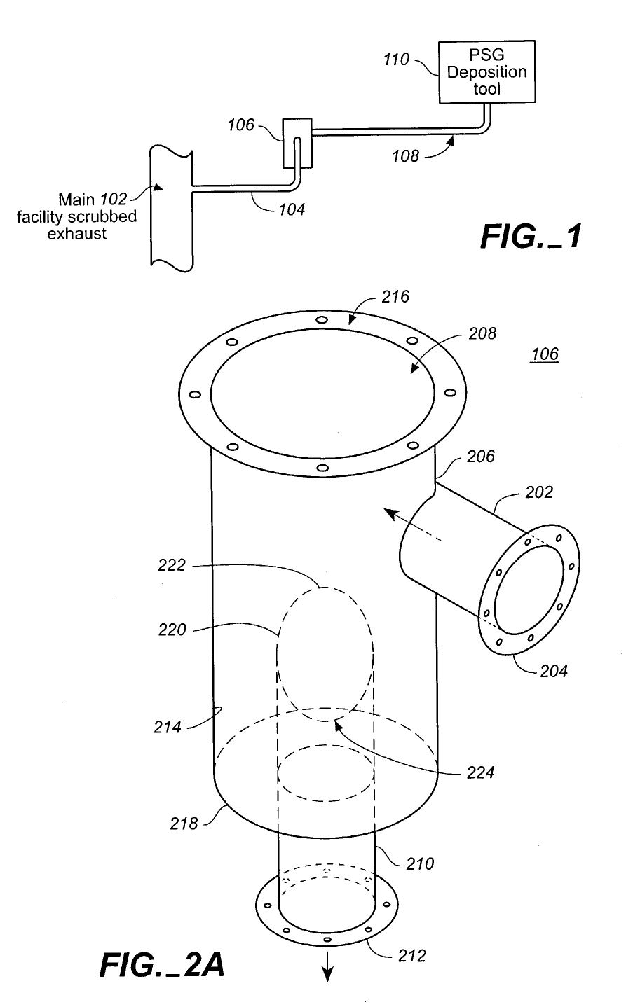

FIG. 1 illustrates a silica trap between a PSG deposition tool and a main exhaust line according to an embodiment of the present invention. Shown in FIG. 1 are a main facilities scrubbed exhaust 102, an outlet exhaust line 104, a PSG deposition tool silica trap 106, a PSG deposition tool exhaust line 108, and a PSG deposition tool 110.

The PSG deposition tool 110 is typically maintained at atmospheric pressure, and waste silica powder is carried in an exhaust stream through the PSG deposition tool exhaust line 108 by a vacuum in the main facilities scrubbed exhaust 102. The exhaust stream typically includes the carrier gases air, ozone, and reacted tetraethylorthosilicate (TEOS). TEOS decomposes at high temperature in the presence of ozone into silicon dioxide and other volatile reactants. These gases conduct the silica powder through the PSG deposition tool exhaust line 108. The exhaust stream enters the PSG deposition tool silica trap 106 where it expands and slows. The silica powder falls out of the exhaust stream and settles to the bottom wall of the PSG deposition tool silica trap 106. The exhaust stream continues out of the PSG deposition tool silica trap 106 through the outlet exhaust line 104 into the main facilities scrubbed exhaust 102.

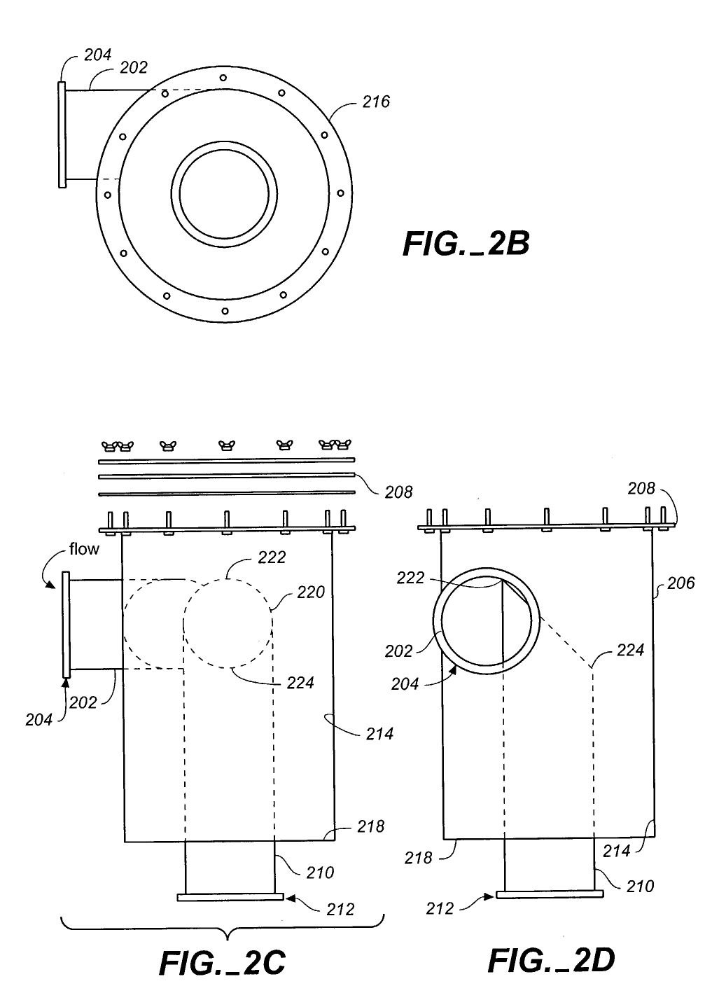

FIGS. 2A, 2B, 2C and 2D illustrate isometric, top, front and side views of the silica trap 106 of FIG. 1. Shown in FIGS. 2A, 2B, 2C and 2D are an inlet 202, an inlet coupling 204, an expansion chamber 206, a access plate 208, a discharge 210, and a discharge coupling 212. The expansion chamber 206 includes a sidewall 214, a top flange 216, and a bottom wall 218. The discharge 210 includes a diagonal cut 220, a high point 222, and a low point 224.

The inlet coupling 204 terminates the inlet 202 and may be, for example, a flange for coupling the inlet 202 to the PSG deposition tool exhaust line 108 in FIG. 1. The inlet 202 may be, for example, a tube or pipe suitable for conducting the exhaust stream from the PSG deposition tool exhaust line 108 into the expansion chamber 206. The inlet 202 may have a diameter of, for example, approximately 15 cm.

The inlet 202 is preferably coupled to the expansion chamber 206 so that the exhaust stream enters the expansion chamber 206 through the inlet 202 tangentially with respect to the sidewall 214. The expansion chamber 206 preferably has a cylindrical shape and a diameter greater than that of the inlet 202 so that the exhaust stream expands and slows inside the expansion chamber 206 and forms a vortex around the sidewall 214 outside the discharge 210. However, other shapes for the expansion chamber 206 may be used to practice the present invention within the scope of the appended claims. The expansion chamber 206 may have a diameter, for example, of approximately 35 cm and a height of approximately 50 cm.

Upon entering the expansion chamber 206, the exhaust stream expands and slows. The silica powder is heavier than the carrier gases in the exhaust stream, so that it falls and settles to the bottom wall 218 of the expansion chamber 206. The carrier gases remaining in the exhaust stream flow out of the expansion chamber 206 through the discharge 210. The discharge coupling 212 terminates the discharge 210 and may be, for example, a flange for coupling the discharge 210 to the outlet exhaust line 104 in FIG. 1.

The discharge 210 may be, for example, a tube or pipe suitable for conducting the exhaust stream from the expansion chamber 206 into the outlet exhaust line 104. The discharge 210 may have a diameter of, for example, approximately 15 cm and is preferably terminated inside the expansion chamber 206 by the diagonal cut 220. The discharge 210 is preferably oriented in the center of the expansion chamber 206 so that the diagonal cut 220 is rotated 270 degrees from the inlet 202 to minimize the leakage of silica powder into the discharge 210. The low point 224 of the discharge 210 preferably has a height above the bottom wall 218 that is substantially equal to the height of the lowest point of the inlet 202 to minimize the leakage of silica powder into the discharge 210. A typical height of the low point 224 of the discharge 210 above the bottom wall 218 is approximately 28 cm. Other shapes and arrangements of the discharge 210 and of the inlet 202 inside the expansion chamber 206 may be used to practice the present invention within the scope of the appended claims.

The sidewall 214 may be terminated above the inlet 202, for example, by the top flange 216. The top flange 216 may have a width of approximately 4 cm to provide a convenient mounting for the access plate 208. The access plate 208 may be, for example, a plate of lexan, glass, plexiglass, or other suitable transparent material fastened to the top flange 216 with a gasket seal according to well known techniques. The access plate 208 may be used to inspect the level of silica powder inside the silica trap 106 to determine when to empty the silica trap 106. Alternatively, a metal plate may be mounted on the top flange 216 to implement the access plate 208. Also, a window may be formed in the sidewall 214 according to well-known techniques for inspecting the level of silica powder inside the expansion chamber 206.

When the silica trap 106 requires cleaning, the access plate 208 may be conveniently removed to allow the silica powder to be removed, for example, by vacuuming. Alternatively, the inlet coupling 204 and the discharge coupling 212 may be fitted with release pins or other quick coupling devices according to well known techniques so that the silica trap 106 may be readily removed and emptied by opening the access plate 208 and inverting the silica trap 106 over a container.

In another aspect of the present invention, a method of removing silica powder from an exhaust stream carrying silica powder from a PSG deposition tool includes steps for conducting the exhaust stream from a PSG deposition tool exhaust line through an inlet into an expansion chamber, settling the silica powder out of the exhaust stream to a bottom wall of the expansion chamber, and conducting the exhaust stream through a discharge out of the expansion chamber.

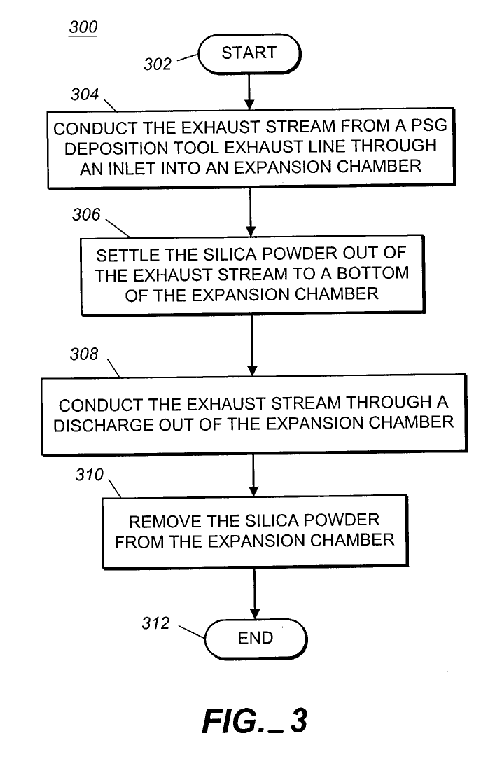

FIG. 3 illustrates a flow chart for a method of removing silica powder from an exhaust stream carrying silica powder from a PSG deposition tool according to an embodiment of the present invention.

Step 302 is the entry point of the flow chart 300.

In step 304, the exhaust stream is conducted from a PSG deposition tool exhaust line through an inlet into an expansion chamber.

In step 306, the silica powder is settled out of the exhaust stream to the bottom wall of the expansion chamber.

In step 308, the exhaust stream is conducted through a discharge out of the expansion chamber.

In step 310, the silica powder is removed from the expansion chamber.

Step 312 is the exit point of the flow chart 300.

Although the methods of the present invention illustrated by the flowchart descriptions above are described and shown with reference to specific steps performed in a specific order, these steps may be combined, sub-divided, or reordered without departing from the scope of the claims. Unless specifically indicated herein, the order and grouping of steps is not a limitation of the present invention.

While the invention herein disclosed has been described by means of specific embodiments and applications thereof, numerous modifications and variations could be made thereto by those skilled in the art without departing from the scope of the invention set forth in the following claims.

What is claimed is:

1. A silica trap for a PSG deposition tool comprising:
an expansion chamber;
an inlet coupled to the expansion chamber for conducting an exhaust stream carrying silica powder from the PSG deposition tool into the expansion chamber so that the silica powder settles out of the exhaust stream to a bottom wall of the expansion chamber; and
a discharge coupled to the expansion chamber to conduct the exhaust stream out of the expansion chamber.

2. The silica trap for a PSG deposition tool of claim 1 wherein the expansion chamber has a sidewall and a bottom wall.

3. The silica trap for a PSG deposition tool of claim 2 wherein the inlet is coupled to the expansion chamber so that the exhaust stream enters the expansion chamber through the inlet tangentially with respect to the sidewall.

4. The silica trap for a PSG deposition tool of claim 1 further comprising an access plate coupled to the expansion chamber for inspecting a level of the silica powder inside the expansion chamber.

5. The silica trap for a PSG deposition tool of claim 4 wherein the access plate is coupled to the top of the expansion chamber.

6. The silica trap for a PSG deposition tool of claim 1 wherein the discharge is oriented in the center of the expansion chamber and is terminated inside the expansion chamber by a diagonal cut rotated about 270 degrees from the inlet to minimize the leakage of silica powder into the discharge.

7. The silica trap for a PSG deposition tool of claim 1 further comprising a quick coupling device for removing and replacing the silica trap to empty the silica powder from the silica trap.

8. A method of removing silica powder from an exhaust stream carrying silica powder from a PSG deposition tool comprising steps for:
conducting the exhaust stream from a PSG deposition tool exhaust line through an inlet into an expansion chamber;
settling the silica powder out of the exhaust stream to a bottom wall of the expansion chamber; and
conducting the exhaust stream through a discharge out of the expansion chamber.

9. The method of claim 8 further comprising a step for inspecting a level of the silica powder inside the expansion chamber through a window in the expansion chamber.

10. The method of claim 8 wherein the step for conducting the exhaust stream into an expansion chamber comprises directing the exhaust stream into the expansion chamber through the inlet tangentially with respect to a sidewall of the expansion chamber.

11. The method of claim 8 wherein the step for conducting the exhaust stream out of the expansion chamber comprises orienting the discharge to minimize the leakage of the silica powder into the discharge.

12. The method of claim 8 further comprising a step for removing the silica powder from the expansion chamber.

13. The method of claim 12 wherein the step for removing the silica powder from the expansion chamber comprises vacuuming the expansion chamber.

14. The method of claim 12 wherein the step for removing the silica powder from the expansion chamber comprises inverting the silica trap over a container.
